(19) United States
(12) Patent Application Publication
(10) Pub. No.: US 2010/0265060 A1
(43) Pub. Date: Oct. 21, 2010

(54) LOCATING AN OBJECT

(75) Inventor: Idy Watt, Issy-Les-Moulineaux (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/745,713

(22) PCT Filed: Dec. 3, 2008
(86) PCT No.: PCT/FR2008/052190

§ 371 Date: Jun. 2, 2010

(30) Foreign Application Priority Data
Dec. 6, 2007 (FR) 07 59623

(51) Int. Cl. G08B 1/08

(52) U.S. Cl. 340/539.13

(57) ABSTRACT

The invention relates to a method of locating an object capable of being located by at least one location unit. The invention comprises a step of selecting at least one location unit as a function of the locale in which the object is situated.

### TECHNICAL FIELD

The invention relates to locating an object and more particularly to locating a mobile object. The mobile object in question is any device that may be geographically located by means of at least one location unit. The object may equally well be a mobile telephone, a personal digital assistant (PDA), a navigation device installed in a vehicle, a contactless card, a badge, etc.

The nature of the location unit is immaterial; these units may be interchangeably location units using GPS (Global Positioning System) satellite positioning, location units using mobile telephone networks, such as the Enhanced Observed Time Difference (EOTD) system, the GSM cell identification system, triangulation, etc. The location unit may also simply be a unit able to receive a location supplied by the user of the mobile object.

### PRIOR ART

At present, many service providers offer location-based services. For example, navigation services offer the possibility of receiving navigation information on a mobile object, the information being adapted to guide movement of a user in possession of the object.

Various location units are used and their respective performance is a function of the locale in which the mobile object is moving.

Consider the example of GPS satellite location units and location units based on mobile telephone networks, but without being limited to these. GPS satellite location units use satellite signals to locate an object; these units offer very high performance when the object to be located is moving in an outdoor environment with good visibility of the sky. Conversely, GPS satellite location units offer very poor performance in places with a low visibility of the sky, for example inside a building. Location units based on mobile telephone networks offer very good performance when the object to be located is situated in an environment with low visibility of the sky, notably inside a building.

At present, location is preceded by a step of selecting the location unit offering the best performance, which is then used to locate the object. Selecting a location unit consists first of all in calculating the position of the object using each of the available location units in succession and then comparing the positions obtained. Selection consists finally in selecting the location unit that gave a position as quickly as possible or that gave a position with the lowest possible estimated uncertainty, for example.

It is apparent that this selection step requires a great deal of time and very high energy consumption by the mobile object. The time given over to selection may be excessive if the location unit encounters difficulties in obtaining a location, for example when the environment in which the mobile object is situated makes the calculation difficult or in the worst case scenario when it cannot locate the object. These difficulties lead to additional waiting times that are intolerable for the user. Consequently, the known solutions do not encourage the user to use such location-based services. The latency times discourage the user and inevitably put a psychological brake on the use of such services. This leads to an undoubted loss of revenue for the provider of the location-based service.

### SUMMARY OF THE INVENTION

An object of the invention is a solution that does not have the drawbacks of the prior art.

To this end, the invention provides a method of locating an object capable of being located by at least one location unit, the method being characterized in that it includes a step of selecting at least one location unit as a function of the locale in which the object is situated.

Thus, according to the invention, choosing the location unit does not require obtaining a location using all the available location units. Choosing the location unit is reduced to choosing a location unit associated with the locale in which the object is situated and preferably a location unit suited to that locale.

In a variant of the method, the selection step is preceded by a step of establishing a correspondence between a locale and at least one respective location unit to be used and the choice of the location unit to be used when locating the object is a function of this correspondence. Thus to each locale there corresponds at least one respective location unit to be used to locate an object. This correspondence is established during a stage preceding location of the object and is used during location of the object. In this way, possibly even before the object travels through a locale, the correspondence established in this way provides the sets of location units to be used.

Note that the locale concerned may be of any kind. It may be a position associated with a coordinate point, a surface, a volume, etc.

In a variant, the locale includes at least two zones associated with at least one respective location unit and switching from a first location unit associated with a first zone to a second location unit associated with a second zone is a function of the above-mentioned correspondence. Accordingly, management of switching from one location unit to another and the choice of the location unit to be used after switching are automatic and transparent for the user and the object. In each zone, the application guarantees the use of the location unit most suited to the locale.

In a variant, if the current position corresponds to a coordinate point in a first zone a probability weighting is assigned to at least one coordinate point situated near the current position and switching from a first location unit to a second location unit associated with a second zone takes place when the point having the highest probability is in the second zone. Thus using a probability weighting distribution makes it possible to predict the direction that the object will take and to envisage switching from the first location unit to the second location unit.

In a variant, weightings are assigned if the current position of the object is such that moving from a first zone to a second zone is probable. The application may judge a move to be probable if the shortest distance between the current position and a surrounding zone is less than a predefined value or if the time to go from the current position to a surrounding zone is less than a predefined time. In this way, the use of probability weightings is limited to certain coordinates, notably to those situated in the vicinity of a surrounding zone. This therefore reduces the use of the physical and software resources of the device responsible for assigning the weightings and for determining whether switching is probable, which device may be the object, for example, or any other device such as a server, as in the embodiment described below.

The proximity between two points may be defined by a distance separating two points or a time for going from one point to the other. The values may be fixed by the navigation application and are chosen to render the optimum service.

In a variant, the probability weighting is a function of the context. The context includes contextual information about the object and/or the user. Information on the user may include information on their use of time, mood or habits, or any other information linked to the user. Information about the object may be the speed of the object, the direction of movement of the object or any other information linked to the object. This information makes it possible to predict the direction that the object will take and thus to trigger switching of the location unit if necessary.

In a variant of the method, the correspondence takes account of the environment of the locale. In this way, the selected location unit is adapted to the environment and supplies an optimum position. Thus if, for example, the locale concerned is in the open air, the correspondence prefers a satellite location unit.

The invention also provides an object, in particular an object able to move around in a locale, and to be capable of being located in the locale by at least one location unit, the object being characterized in that it includes means able to select a location unit as a function of the locale in which the object is situated.

The invention further provides a device, such as a server, able to locate an object via at least one location unit, the device being characterized in that it includes selection means able to select a location unit to locate the object as a function of the locale in which the object is situated.

The invention further provides a computer program including code instructions that, when it is executed by a data processing device, execute the steps of the method defined above.

The invention further provides a storage medium readable by a data processing device and storing a computer program including code instructions for executing the steps of the method defined above.

The invention can be better understood on reading the following description that is given by way of example and with reference to the appended drawings.

### IN THE DRAWINGS

FIG. 1 shows a computer system illustrating the location method of one implementation of the invention.

FIG. 2 shows one example of a locale in which an object is able to move.

FIG. 3 is an example of the correspondence between a locale and at least one respective location unit to be used. This example relates to the locale to which FIG. 2 relates.

FIG. 4 shows a flowchart illustrating the method of one implementation of the invention.

The invention can be better understood after reading the following description given by way of example and with reference to the appended drawings.

### DETAILED DESCRIPTION OF AN IMPLEMENTATION OF THE INVENTION

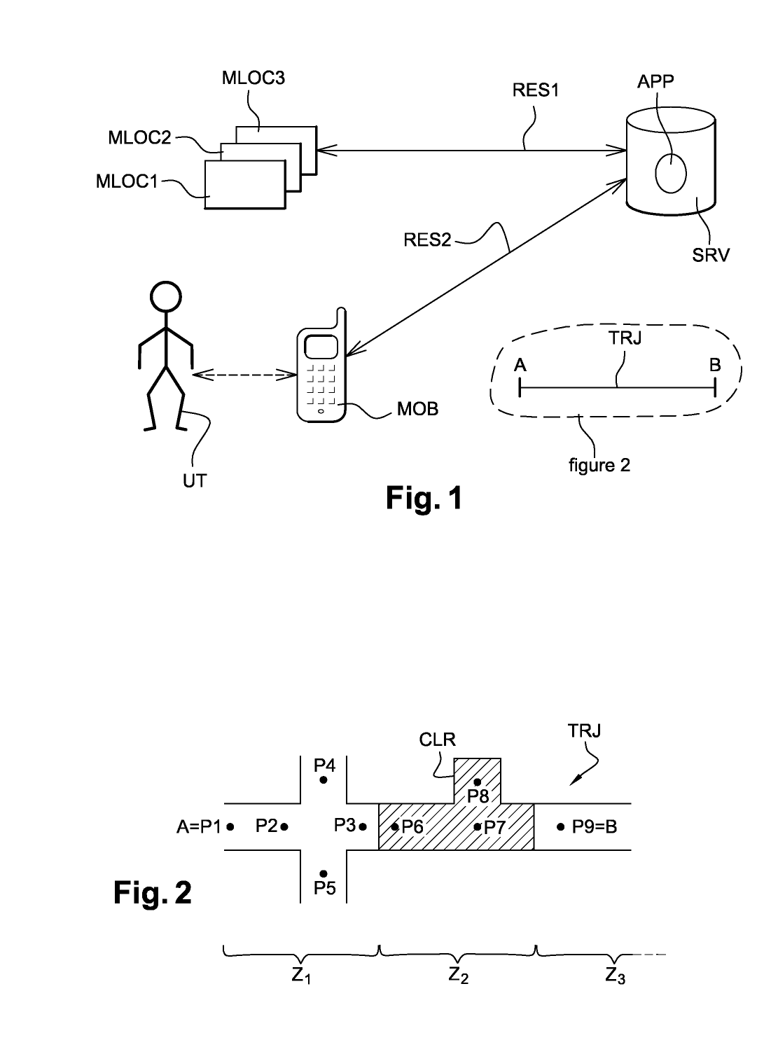

FIG. 1 shows a computer system SYS in which the invention may be used and a locale, represented in this example by a path TRJ that a user UT in possession of an object MOB is liable to take. In this example this object is mobile.

The system includes a data processing device represented as a server SRV. The server SRV stores a navigation application APP able to guide the user. Note that the data processing device includes at least one microprocessor and hardware and/or software resources suitable for processing data.

In this example, the server communicates with three location units MLOC1, MLOC2, MLOC3 via a first network RES1 to obtain location information relating to the mobile object MOB. For example, one of the location units is a GPS (Global Positioning System) system, a GSM (Global System for Mobile communications) system, GPRS (General Packet Radio Service), WLAN (Wireless Local Area Network), etc.

The application APP is also able to provide the user of the mobile object MOB with navigation information. The navigation information is transmitted from the server to the object via a second communications network RES2 of any type, which may be the same network as the first network RES1.

The navigation information is generally accessible visually on a screen of the mobile object that the user may read. The navigation information generally provided takes the form of a map on which the current position of the mobile object is shown together with the intended route if the user has defined a path TRJ.

Note that receiving location data and supplying navigation information may be effected by two separate applications.

In this example, the user travels a path TRJ divided into three zones, namely a first zone Z1, a second zone Z2, and a third zone Z3. The subdivision into zones is effected, judiciously or otherwise, as a function of the context, namely the environment of the zone in question and the predefined preferences of the user. The user's preferences may also be learned by the server SRV or the object MOB itself, for example, or any other network device. For example, one preference of the user might be to receive a relatively coarse location when traveling on a motorway in a car and thus to use a location unit that is not necessarily that best suited to the environment. For example, the user might consider that an accurate location is not of crucial interest when on a motorway. This situation may arise when the user knows the route well and is using the location service only to obtain information on particular points of interest situated near the path TRJ, such as service stations, restaurants, etc.

According to the invention, to each zone there corresponds a respective location unit MLOC1, MLOC2, MLOC3 that is to be used. In this example, to simplify the description of the invention, the correspondence is a logical relationship between a position and a location unit. However, the invention is not limited to this example and encompasses correspondence between a position and a plurality of location units.

FIG. 2 is an example of a path on which the mobile object MOB may move. The path in question corresponds to the segment AB. This path includes three zones Z1, Z2, Z3 each having a particular environment. In fact, in this example, the first zone is a zone in the open air, the second zone is a shopping center, and the third zone is a tunnel.

FIG. 4 is a flowchart comprising a series of steps illustrating the method of one implementation of the invention.

During a first step ET1 in this example, the user uses the mobile object to inform the application that the intended path is the path AB.

During a second step ET2, the navigation application APP divides the path TRJ into zones Z1, Z2, Z3 and makes these three zones correspond with respective location units MLOC1, MLOC2, MLOC3 as a function of the environment. As mentioned above, if carefully chosen, this correspondence is a function of the environment linked to the zones. In this example, a correspondence table is drawn up as a function of the data relating to the environment. In this database:
the first location unit MLOC1 corresponds to the first zone Z1;
the second location unit MLOC2 corresponds to the second zone Z2;
the third location unit MLOC3 corresponds to the third zone Z3.

For example, the carefully chosen location units could be a satellite location unit for zone Z1, a WIFI location unit for the second zone Z2, and a GSM location unit for the third zone Z3.

In a variant of the second step, a plurality of location units may correspond to each zone. Under these conditions, the choice of a location unit could be a function of preferences specified by the user, in addition to the information relating to the environment. The user may in fact define an unlimited number of preferences that will be taken into account when choosing the location unit to be used, notably when a zone corresponds to a plurality of location units.

Note that the order of executing the first and second steps is immaterial. For example, the second step could be executed after the first and the resulting correspondence stored in a database before the user utilizes the navigation application.

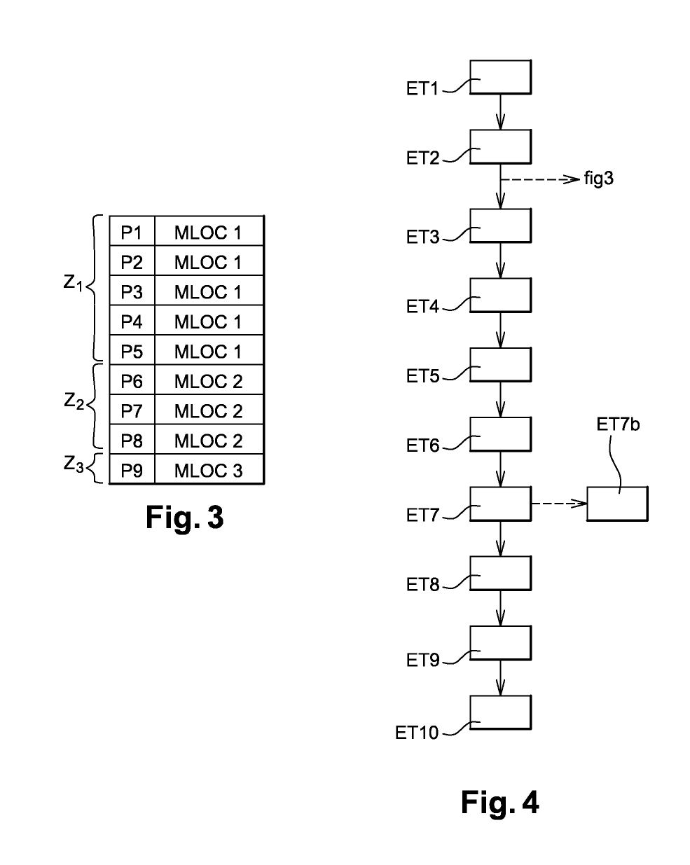

After the first and second steps, the application APP has access to the table shown in FIG. 3. In that table:
the location unit MLOC1 corresponds to the positions P1 to P5 of the first zone Z1;
the location unit MLOC2 corresponds to the points P6 to P8 of the second zone Z2; and
the third location unit corresponds to the point P9 of the third zone Z3.

During a third step ET3, when the user UT in possession of the mobile object MOB is moving in the first zone Z1, the application APP locates the object via the first location unit MLOC1 and provides navigation information as a function of that location.

In this example, to ensure the optimum quality of service, the server makes requests for the mobile object to be located as often as possible in order, whenever necessary, to switch from the current location unit MLOC1 to another location unit as quickly as possible.

During a fourth step ET4, the object is located at the position P3. Knowing the path AB, the navigation application deduces a high probability that the user will enter the second zone Z2. The probability may also be based on a context indicating the habits of the user UT, their current state, their direction, the means of transport they are using, the corresponding speed, the weather, etc. For example, if the user has indicated a keen interest in shopping centers, or if this is known by means of learning mechanisms, the probability of going from the point P3 to the point P6, and thus from the first zone Z1 to the second zone Z2, is high. The navigation application may then anticipate this move and, referring to the table shown in FIG. 3, envisage switching from the first location unit MLOC1 to the location unit that corresponds to the point P6, namely the second location unit.

The application may assign probability weightings to the points surrounding the point P3 as a function of data linked to the user's habits. In fact, in this implementation, if the object is situated at a coordinate point in the first zone, a probability weighting is assigned to at least one coordinate point situated near the current point and if said at least one point is situated in the second zone, switching from the first zone to the second zone is a function of the probability weighting. A plurality of points usually surrounds the coordinate point representing the current position of the object. Under such circumstances, if the object is situated at a coordinate point of the first zone, a probability weighting is assigned to the points around the current point and switching from the first zone to the second zone occurs when, of all the points concerned around the current point, the point having the highest probability belongs to the second zone. In concrete terms, in this example, the application may assign probability weightings to the points around the point P3 as a function of data linked to the user's habits. For example, referring to FIG. 2, the weightings (expressed as percentages) associated with the points P2, P4, P5 around the current point P3 could be as follows: P2: 5%, P4: 15%, P5: 15%, P6: 65%. In this example, the weighting associated with the point P6 is such that switching from the first location unit to the second location unit may occur.

During a fifth step ET5, the application performs a switching operation linked to the use of the location unit, switching from the first location unit MLOC1 to the second location unit MLOC2.

During a sixth step ET6, after switching has taken place, the second location unit MLOC2 locates the object MOB at P6. During a seventh step ET7, the second location unit

MLOC2 locates the object at the point P7. During a step ET7b, the application consults the above-defined predefined table (cf. FIG. 3) and therefore detects the approach of a third zone Z3. In this example, probability weightings are then assigned to the surrounding points P6, P8, P9 as a function of certain parameters, for example the habits of the user UT. For example, consider a user keen on cutting edge technology. Because in the dead-end corridor CLR of the shopping center, represented by the point P8, there are stores selling high-tech products, a probability weighting will be assigned to the points surrounding the point P7 as a function of this data. For example, the distribution of weightings (expressed as percentages) might be as follows: P6: 5%, P8: 70%, P9: 25%, meaning that it is very improbable that the user will turn back, that it is improbable that the user will go into the third zone Z3, and that it is highly probable that the user will take the corridor CLR. As a function of these weightings, the application switches if the point with the highest weighting belongs to a zone other than the current zone. Here, the highest weighting is associated with a point in the same zone; the application therefore does not switch location unit.

A user in possession of the object and moving quickly at the usual time for going to work, etc., could have the consequence of modifying the distribution of the weightings in the following manner, for example: P6: 5%, P8: 20%, P9: 75%. The information that the user is in a hurry might come from information taken from the user's diary, indicating for example that the user has an appointment shortly.

During an eighth step ET8, the user is located at the point P8.

During a ninth step ET9, since the corridor is a dead end, the user returns to the point P7. At the point P7, the probability weightings are distributed in the following manner: P6: 5%, P8: 0%, P9: 95%. The distribution of the weightings is such that switching from the second location unit MLOC2 to the third location unit MLOC3 may be effected. The application therefore switches from the second location unit MLOC2 to the third location unit MLOC3.

During a tenth step ET10, the application locates the object at the position P9 by means of the third location unit MLOC3 and terminates the navigation function. In this example, the application calls for a message to be displayed on the screen of the mobile object MOB, informing the user that the destination has been reached.

The probability weightings may be obtained by particular constrained filtering on a Voronoi diagram.

In a variant, to avoid using probability weightings at each location of the object, a transition zone may be defined between zones. Outside this transition zone, the application considers that there is no need to use probability weightings because it considers that the current position of the object is sufficiently far from the adjacent zones for movement from one zone to another to be highly improbable.

A transition zone may be defined by means of a distance or a time T before which the application decides that switching of location unit is liable to occur. The distance D is the distance separating the current position of the mobile object and a point in an adjacent zone. The time T is the time necessary to move from the current position to a point in an adjacent zone.

The estimated time to move from the current position to a point in an adjacent zone may be calculated as a function of the current travel speed of the mobile object and of weather forecasts linked to the zone concerned, for example.

As pointed out above, switching is a function of a probability weighting distribution. Alternatively, the object MOB may also inform the server that switching is required. This requirement may come from the user, who is able to give information about travel direction and thus about the coordinate points that they intend to pass through. The server thereafter receives this information from the object and performs the switching when the current position of the object is near a zone other than the current zone. This variant is beneficial when the user has not given any destination B, the navigation application having only the starting position and possibly context information. It is therefore clear that the invention is not limited to the implementation based on a path AB but extends to examples in which the destination B is unknown. In fact, as mentioned above, information supplied by the user, the probability weighting distribution, would in itself make it possible to guess the direction that a user might take.

Note also that when a correspondence provides a list of location units including a plurality of location units for a zone, selection of the location unit to be used may come from different sources. For example one source might be the user, who selects the location unit to be used. The source may also be software and able to provide a performance indication, an average performance relative to the other units from the list at a given time.

1. A method of locating an object capable of being located by at least one location unit, the method comprising a step of selecting at least one location unit as a function of the locale in which the object is situated.

2. The method according to claim 1, wherein the selection step is preceded by a step of establishing a correspondence between at least one locale and at least one respective location unit to be used and in that the choice of the location unit to be used when locating the object is a function of this correspondence.

3. The method according to claim 2, wherein if the current position corresponds to a coordinate point in a first zone a probability weighting is assigned to at least one coordinate point situated near the current position and switching from first location unit to second location unit associated with a second zone takes place when the point having the highest probability is in the second zone.

4. The method according to claim 3, wherein weightings are assigned when the current position of the object is such that a move from a first zone to a second zone is probable.

5. The method according to claim 3, wherein the probability weighting is a function of the context.

6. The method according to claim 1, wherein selection takes into account the environment of the locale.

7. The method according to claim 3, wherein the context includes contextual information on the object and/or the user.

8. An object capable of being located in a locale by at least one location unit, the object comprising means able to select a location unit as a function of the locale in which the object is situated.

9. A device able to locate an object via at least one location unit, the device comprising selection means able to select a location unit to locate the object as a function of the locale in which the object is situated.

10. A computer program comprising code instructions that, when it is executed by a data processing device, execute the steps of the method according to claim 1.

11. A storage medium readable by a data processing device storing a computer program comprising code instructions for executing the steps of the method according to claim 1.
